(19) United States
(12) Patent Application Publication
(10) Pub. No.: US 2015/0244537 A1
(43) Pub. Date: Aug. 27, 2015

(54) SYSTEM AND METHODS FOR ENABLING POLICY EXCHANGE ACROSS MULTIPLE CARRIERS

(71) Applicant: Tata Communications (America) Inc., Herndon, VA (US)

(72) Inventors: Fred Paquette, Herndon, VA (US); Charles Abondo, Herndon, VA (US); Catherine Livet, Herndon, VA (US); John Kern, Herndon, VA (US); Brian Peebles, Cranford, NJ (US)

(21) Appl. No.: 14/628,460

(22) Filed: Feb. 23, 2015

Related U.S. Application Data
(60) Provisional application No. 61/943,450, filed on Feb. 23, 2014.

(51) Int. Cl. H04L 12/14; H04M 15/00; H04W 4/24

(52) U.S. Cl. CPC H04L 12/1453; H04L 12/1403; H04W 4/24; H04M 15/8038; H04W 84/042

(57) ABSTRACT

Systems and methods that enable a Home network to control and enforce its policies across other networks are disclosed.

### STATEMENT OF RELATED CASES

This case claims priority of U.S. Provisional Patent Application Ser. No. 61/943,450, filed Feb. 23, 2014, and which is incorporated by reference herein.

### FIELD OF THE INVENTION

This invention pertains to mobile networks.

### BACKGROUND OF THE INVENTION

Today's mobile network operator (MNO) keeps a detailed user record in its database. Those records can be used to control a mobile user's ability to access the mobile network and the capabilities available to the user when using the mobile network. For example, user account information can be used to determine if the user can access the mobile network and at what usage level. User device information can be used to determine, for example, if the content the user wishes to access is to be blocked (blacklisted), prioritized, authorized during only a certain period of time, or balanced with other content from other users. These actions are called “policies;” policies govern how user traffic behaves in the network. Policy governance is not simply restricted to mobile networks. Landline and WiFi networks make use of polices as well.

A mobile user (hereinafter “subscriber”) will often have an account with one mobile network operator and “visit” another network operated by an MNO with which they have no account. This happens frequently in the mobile network community and is referred to as “roaming.”

In a roaming scenario, a subscriber is attempting to use their mobile phone in an operator's network (3G or LTE) other than the network (3G or LTE) with whom the subscriber holds an account. The account-related network is referred to as the “Home” network or more formally as the “Home Public Land Mobile Network” or “HPLMN”. When roaming, the subscriber is located in an area served by a visited network, known formally as the “Visited Public Land Mobile Network” or “VPLMN”.

Referring now to FIG. 1A, when roaming subscriber 110 attempts to establish a data session (e.g., access the Internet, etc.) using a mobile phone, VPLMN 104 must first contact HPLMN 102 to verify that this subscriber is in good standing with the HPLMN and can be allowed onto the visited network.

The roaming subscriber's data is sent, across GPRS roaming exchange (GRX) 106, from visited network 104 to home network 102, where the traffic is allowed onto the Internet via internet service provider (ISP) 108. Data traffic 112 is then brought back through home network 102 to visited network 104 and to roaming subscriber 110.

Data roaming is very expensive and creates long latencies, leading to a very unsatisfactory experience. As a result, most subscribers turn off the data-roaming options on their phone and use WiFi instead. That subscriber behavior deprives the mobile operators of significant revenue. In order to address this trend, MNOs need to create a lower-cost solution, which will also attract more subscribers.

In order to reduce the data path latency created by subscriber traffic needing to traverse the GRX 106 network, the industry has a concept known as Local Break Out (LBO). With LBO, depicted in FIG. 1B, the concept is for the roaming subscriber's data to route directly to the VPLMN's GGSN or PGW and not to backhaul all the way from the HPLMN's GGSN or PGW. In order for the roaming user to accomplish this, their HPLMN must authorize the roaming subscriber's LBO access and control the VPLMN's network using policies prescribed by the HPLMN. This policy exchange is conducted by sending the data policies from the home network Policy and Charging Rules Function server (“H-PCRF”), located in the HPLMN, to the visited network Policy and Charging Rules Function server (“V-PCRF”), not depicted, through the DIAMETER-based S9 interface (not depicted).

Optionally, the HPLMN's Online Charging System (OCS) can be used to conduct real-time policy across the network to the VPLMN's PCEF/PGW. Both the S9 (PCRF) and Gy (OCS) interfaces can be accommodated in any given solution, although only one of them would be used for PCEF/PGW control at any given time.

This arrangement enables HPLMN 102 to maintain policy on subscriber 110 and track their usage 112 while the subscriber roams in the VPLMN, using the VPLMN's access to ISP 109. The HPLMN control's the subscriber's policy and therefore can settle the payments with the subscriber, some of which payments go back to VPLMN 104. This arrangement, however, is typically prohibitively expensive to the subscriber and the connection is often of inferior quality. This solution also involves close cooperation between the HPLMN and VPLMN in terms of policy interoperability, signaling interoperability and payments. Often times, the signaling supported by each operator is different as different operator's use different vendor's equipment and support custom variants to enable the particular operator's network.

### SUMMARY

The present invention provides architectures and methods that enable a Home network to control and enforce its policies realizing similar benefits to LBO from quality of service and cost savings perspective, but in a manner that is much easier and more cost effective to deploy, operate, and support. These architectures and methods are improvements of the “Local Break Out” arrangement.

### BRIEF DESCRIPTION OF THE DRAWINGS

FIG. 1A depicts a prior-art broadband roaming scenario using GRX.

FIG. 1B depicts a prior-art broadband roaming scenario using LBO.

FIG. 2 depicts a first embodiment of an architecture and method for broadband roaming in accordance with the present teachings.

FIG. 3 depicts a second embodiment of an architecture and method for broadband roaming in accordance with the present teachings.

FIG. 4 depicts a third embodiment of an architecture and method for broadband roaming in accordance with the present teachings.

FIG. 5 depicts a fourth embodiment of an architecture and method for broadband roaming in accordance with the present teachings.

FIG. 6 depicts a fifth embodiment of an architecture and method for broadband roaming in accordance with the present teachings.

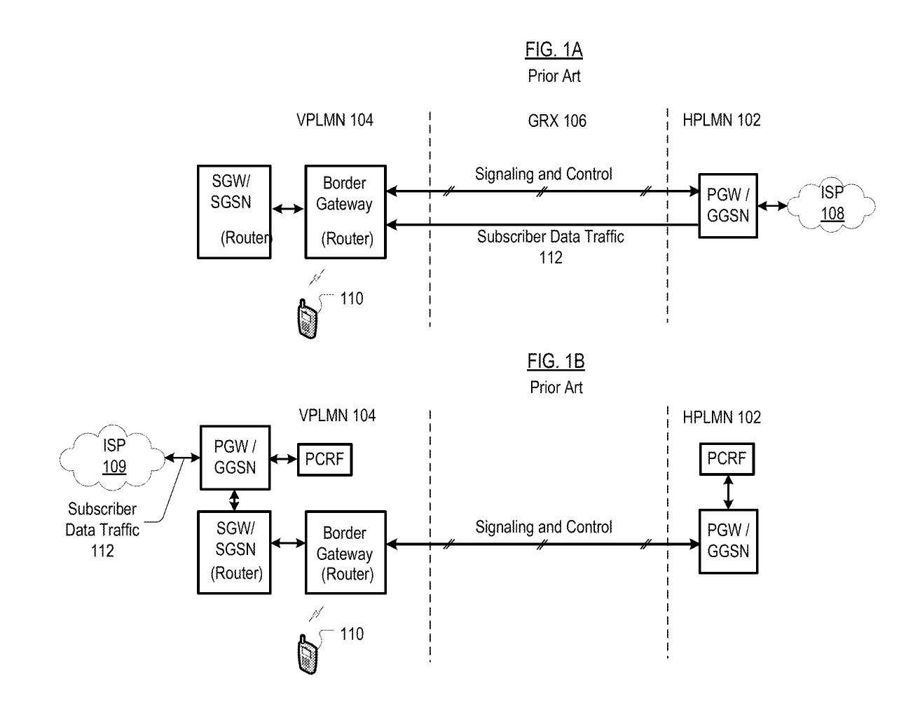

### DETAILED DESCRIPTION

### Acronyms

GGSN: A Gateway GPRS Support Node is part of the core network that connects GSM-based 3G networks to the Internet. The GGSN is a router that works in tandem with the SGSN to keep mobile users connected to the Internet and IP-based applications. The GGSN is also linked into hosted services (such as voice and video) and to the billing, policy control, and user verification elements of the core network.
PGW: The Packet Gateway is the equivalent to the GGSN for the fourth generation packet core (EPC). It assumes most of the same function as the GGSN. In many networks, PGW and GGSN are integrated together in a single node.
SGSN: The Serving GPRS Support Node is a main component of the GPRS network, which handles all packet switched data within the network, e.g., the mobility management and authentication of the users. The SGSN performs the same functions as the MSC for voice traffic. It is a local gateway.
SGW: The Serving Gateway in 4G replaces the SGSN for the routing and handling of the subscriber data sessions, the authentication and mobility management are handled by another node called the Mobility Management Entity (MME). The SGW and MME combined together are replacing the SGSN in 4G.
OCS: Online charging system is a system allowing a MNO to charge their customers, in real time, based on service usage.
PCEF: The Policy and Charging Enforcement Function, PCEF, is a functional element (software) that encompasses policy enforcement and follow-based charging functionalities. This functional element is located at the Gateway (PGW). It is responsible of providing controller functions in traffic handling and QOS at the Gateway over the user plane, and providing service data flow detection, counting with including online and offline different charging interactions.
PCRF: Policy and Charging Rules Function, PCRF, is a functional element (software) that encompasses policy control decision and flow-based charging control functionalities. The PCRF makes intelligent policy decisions for each subscriber active in the network automatically. The PCRF and PCEF are closely related; basically the PCRF provides network control relating to service data flow detection, QoS, and flow-based charging controlling to the PCEF whereas the PCEF provides user traffic handling and QoS at the gateway.
Gx: This is a policy interface that is used between the PGW/PCEF and PCRF for policy and charging rules (PCC).
Gy: This is an online charging interface between the PGW and the OCS.
   The term “data service” includes the Internet, machine-to-machine services, captive services such as voice and Blackberry, CDN services such as sponsored data.
   All the principles described in this claim are applicable to 2G, 2.5G, 3G, 4G/LTE, 5G, and beyond.

The Figures and description provided herein depict various embodiments of an “exchange” that provides connectivity between multiple “home” mobile voice/data telecommunications networks and multiple “visited” mobile voice/data telecommunications networks.

Embodiments of the exchange comprise a data processing system, including processors for executing machine-executable commands, processor-accessible storage, transceivers for receiving and transmitting data, controllers, routers, and the like. All elements of the exchange are known to those skilled in the art, but organized in new ways that afford functionality heretofore unavailable and unknown.

Many of the important elements of mobile telecommunications networks, and of the various embodiments of the exchange that is subject of the invention, are implemented as software, i.e., processor-executable instructions. It is conventional in the telecommunications arts to refer to such software as functional elements, and that convention is adopted herein. Of course, all such software is running on processors located in servers, gateways, controllers, routers, etc. Those skilled in the art will be familiar with all such functional elements and understand the functionality thereof and the manner in which they interact with other elements of data networks (e.g., the Internet) and wireless telecommunications networks.

To maintain a focus on what is germane to the invention, and as will be appreciated by those skilled in the art, only a few of the many hardware and software elements that comprise the mobile voice/data telecommunications networks are depicted in the drawings.

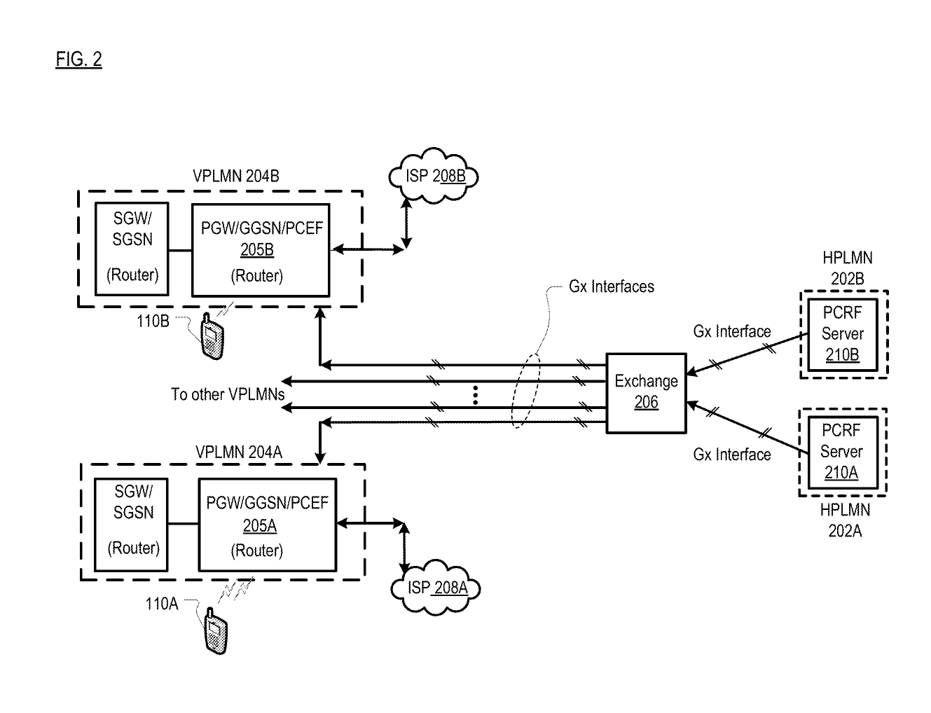

FIG. 2 depicts a first embodiment of system 200 and method for broadband roaming in accordance with the present teachings. In this embodiment, the Gx, DIAMETER-based Protocol signaling output from Policy Charging and Rules Function (PCRF) of each home network is mapped, via exchange 206, to the Policy Charging and Enforcement Function (PCEF) of each VPLMN with whom the HPLMN has a roaming relationship.

In FIG. 2, for example, the signaling output from PCRF server 210A of HPLMN 202A is mapped, via exchange 206, to the PCEF running on router 205A in VPLMN 204A and to the PCEF running on router 205B in VPLMN 204B. Likewise, the signaling output from Policy Charging and Rules Function (PCRF) 210B of HPLMN 202B is mapped, via exchange 206, to the PCEF running on router 205A in VPLMN 204A and to the PCEF running on router 205B in VPLMN 204B.

In many networks, the PCEF is contained within the Operator's Packet Gateway (PGW/GGSN) router, but that function can be segregated and lies instead outside the router on the Internet side of the Packet Gateway.

In any policy-based model, the Gx interface is the Standards-based signaling path between a PCRF and a PCEF. More importantly, exchange 206 can map this Gx information to every Packet Gateway of every Visited Network with whom the Home network has a partnering relationship.

Exchange 206 comprises a Diameter Signal Controller (DSC) including Interworking function (IWF), Diameter Edge Agent (DEA), and Diameter Routing Agent (DRA) functionality, as are well-known in the art. The IWF, DEA, and DRA are specialized software, in the form of processor-executable instructions, executed by the DSC.

Exchange 206 adapts the Gx interface message content from the home networks and delivers it to each Packet Gateway for each VPLMN. Thus, when a HPLMN subscriber visits a VPLMN, the policies that control that subscriber's account will be delivered from the HPLMN's PCRF via Exchange 206 to the VPLMN's PCEF. The VPLMN's PCEF then routes the subscriber's data traffic to, for example, the Internet, just as if the subscriber were ‘homed’ to the visited network.

Thus, similar to the prior-art LBO, data for the roaming subscriber does not have to be backhauled to the home network. However, unlike the prior-art LBO, the close cooperation between the HPLMN and VPLMN in terms of policy interoperability, signaling interoperability and payments are avoided due to the ability of exchange 206 to the use of standard Gx interface.

Although two VPLMNs are depicted in FIG. 2, it is to be understood that this architecture and method enables a single HPLMN to control roaming policy in an arbitrary number, N, of Visited networks. And, of course, this embodiment contemplates a plurality of HPLMNs each controlling their roaming policy in any number of Visited networks. This embodiment of an improved LBO architecture and method requires/enables, in addition to any other capabilities and benefits:
Minimal changes to the HPLMN;
Minimal intervening equipment in Exchange 206;
An approach by which an HPLMN controls policy in a VPLMN for LBO subscribers;
An approach by which a single HPLMN PCRF cluster can control roaming policy in “N” Visited Networks;
An approach by which interoperability is achieved via Gx signaling-traffic adaption that is done during run-time operation to adapt to any PGW, regardless of make and model; and
A VPLMN to have a single point of integration to the exchange to interconnect transparently with multiple HPLMNs.

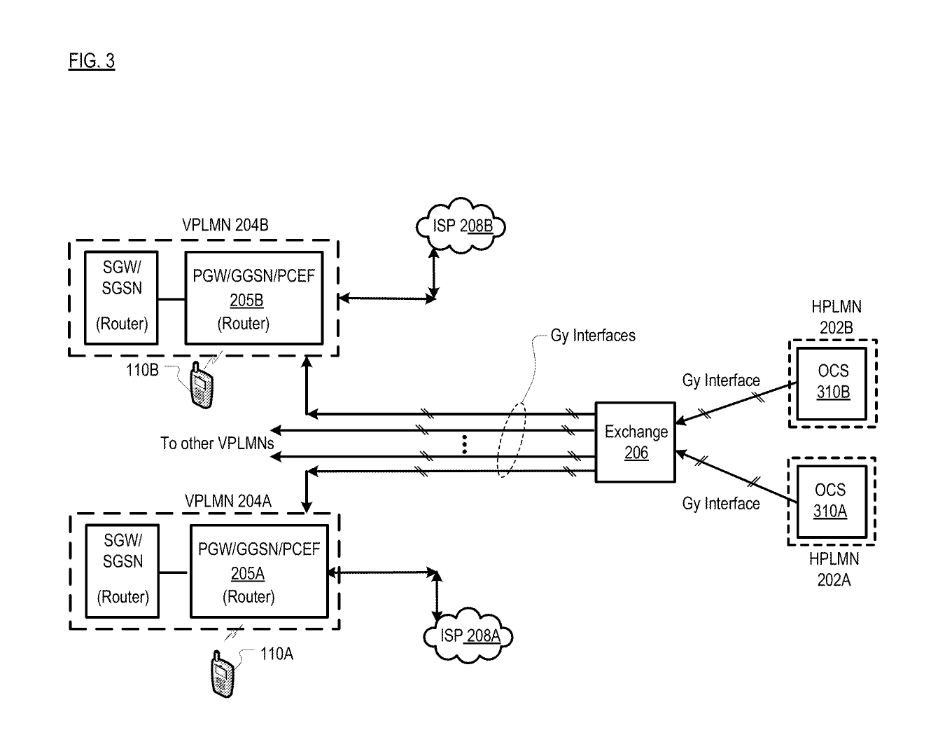

FIG. 3 depicts a second embodiment of an architecture and method for broadband roaming in accordance with the present teachings.

In this embodiment, exchange 206 receives information from the home networks over the Gy interface rather than the Gx interface. That is, the HPLMN's Online Charging System (OCS) is used to map information, in real time, via exchange 206, to the VPLMN's PCEF. A difference between this embodiment and the one depicted in FIG. 2 is that this embodiment requires integration with each HPLMN's OCS system. Like the first embodiment, this embodiment enables a single HPLMN to control roaming policy in an arbitrary number, N, of Visited networks. And, of course, this embodiment contemplates a plurality of HPLMNs each controlling their roaming policy in any number of Visited networks.

Thus, Gy, DIAMETER-based Protocol signaling output from OCS 310A of HPLMN 202A is mapped, via exchange 206, to the Policy Charging and Enforcement Function (PCEF) running on router 205A in VPLMN 204A and to the PCEF running on router 205B in VPLMN 204B. And the signaling output from OCS 310B of HPLMN 202B is mapped, via Gy exchange 306, to the Policy Charging and Enforcement Function (PCEF) running on router 205A in VPLMN 204A and to the PCEF running on router 205B in VPLMN 204B.

The VPLMNs then directly access a desired data service, such as ISPs 208A or 208B, to provide the requested content to the roaming subscriber 110A or 1106.

Once again, exchange 206 uses a Diameter Signal Controller (DSC) including Interworking function (IWF), Diameter Edge Agent (DEA), and Diameter Routing Agent (DRA) functionality.

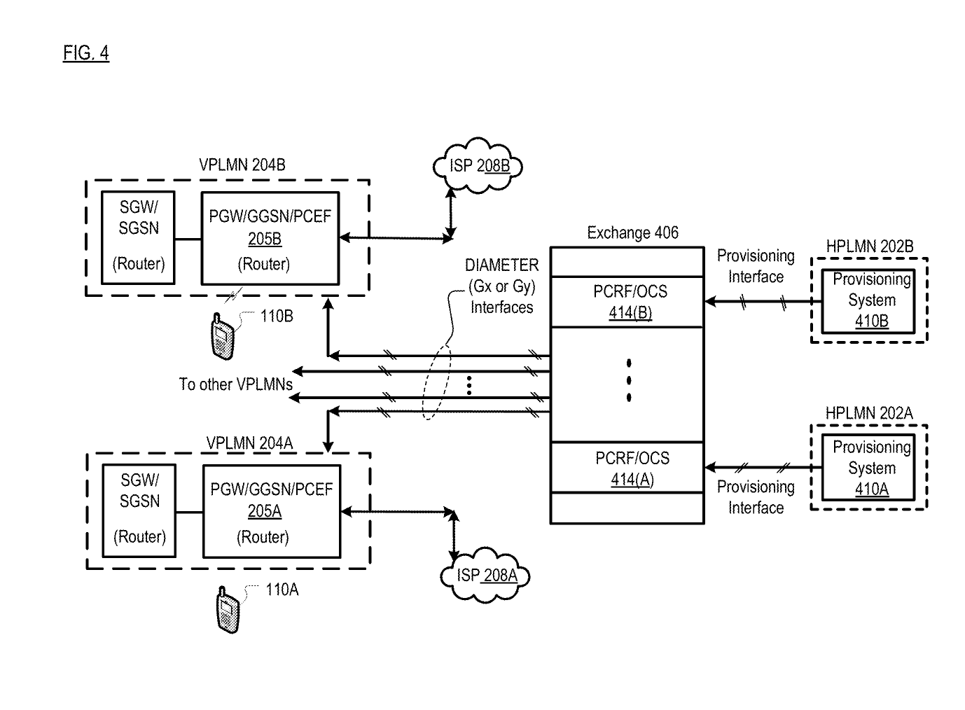

FIG. 4 depicts a third embodiment of an architecture and method for broadband roaming in accordance with the present teachings. This embodiment is somewhat more complex than the embodiments of FIGS. 2 and 3.

In the third embodiment, rather than relying on the HPLMN to have a PCRF server or OCS, a PCRF server(s) or OCS is provided locally in exchange 406. In this embodiment, the exchange comprises plural PCRF or OCS instances, wherein a specific instance of the PCRF or OCS is allocated to each HPLMN using the exchange. This effectively provides a centralized policy controller for more advanced operations, enabling, for example, a group of mobile network operators to use a common control point for exchanging roaming policy.

This embodiment requires that the provisioning system of each HPLMN using exchange 406 accesses its private instance of a PCRF server or OCS in the exchange, establish subscriber data entries, create policies, and assign those policies to the subscribers who enter a visited network. Thus, for example, provisioning system 410A of HPLMN 202A accesses, over a provisioning interface, PCRF or OCS 414(A) and provisioning system 410B of HPLMN 202B accesses, over a provisioning interface, PCRF or OCS 414(B).

Either a Gx or Gy interface is used between the PCRF or OCS instances in exchange 406 and the PCEF (e.g., 205A, 205B, etc.) of visited networks (e.g., VPLMNs 204A, 204B, etc.). Since only a single PCRF or OCS instance is needed to enable a single HPLMN, each instance can be used to generate Gx or Gy for each of the VPLMNs.

The VPLMNs then directly access a desired data service, such as ISPs 208A or 208B, to provide the requested content to the roaming subscriber 110A or 1108.

As in the previous embodiments, this embodiment enables a single HPLMN to control roaming policy in an arbitrary number, N, of visited networks (VPLMNs) and contemplates a plurality of HPLMNs each controlling their roaming policy in any number of visited networks.

This embodiment of an improved LBO architecture and method enables, in addition to any other capabilities and benefits:
An approach by which a common policy control point can be established for multiple mobile network operators to share policy;
An approach by which an HPLMN can provision roaming policies and subscribers independently of their home network PCRF; and
An improved response time for policy establishment.

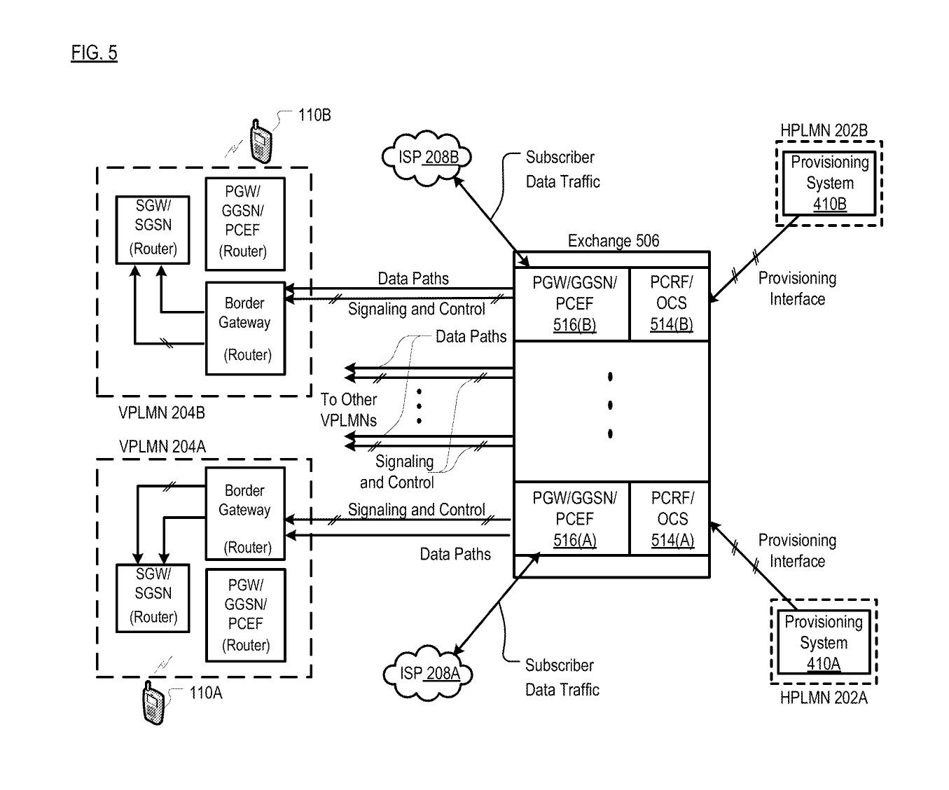

FIG. 5 depicts a fourth embodiment of an architecture and method for broadband roaming in accordance with the present teachings. This embodiment does not require the interaction with a visited network, although alternative connectivity with the visited network, as opposed to using GRX/IPX, is optionally supported and in some cases preferred.

Exchange 506 is effectively an extension of the home network (HPLMN) into regions that are in proximity to an HPLMN's outbound roamers. Exchange 506 is not necessarily located adjacent to the visited or home Mobile operator. Rather, it is advantageously positioned in regionally local data centers to optimize its ability to pull traffic from multiple visited networks within that region and provides what can be referred to as Regional Breakout (RBO). Exchange 506 may support multiple HPLMNs, and HPLMNs may be supported by multiple exchanges 506.

Traffic is routed between exchange 506 and visited networks based on network routing instructions received from each HPLMN. Within exchange 506, the traffic associated with outbound roamers of a specific HPLMN, traverses PGW/GGSN/PCEF instance(s) dedicated to that HPLMN as it is broken out to an internet service provider (ISP) local to that region. The PGW/GGSN/PCEF instance(s) interact with other HPLMN subsystems (e.g., PCRF, OCS, etc.) to apply the HPLMN's Policy Control and Charging capabilities.

For example, instance of PCRF or OCS 514(A) receives traffic/instructions from provisioning system 410A of HPLMN 202A. The traffic/instructions traverses instance of PGW/GGSN/PCEF 516(A). Data traffic obtained via ISP 208A is routed via PGW/GGSN/PCEF 516(A) to VPLMN 204A and then to subscriber 110A. HPLMN 202A, via instances PCRF or OCS 514(A) and PGW/GGSN/PCEF 516(A) can also route to VPLMN 204B. Similarly, HPLMN 202B can route to either VPLMN 202A or VPLMN 202B via instances PCRF or OCS 514(B) and PGW/GGSN/PCEF 516(B).

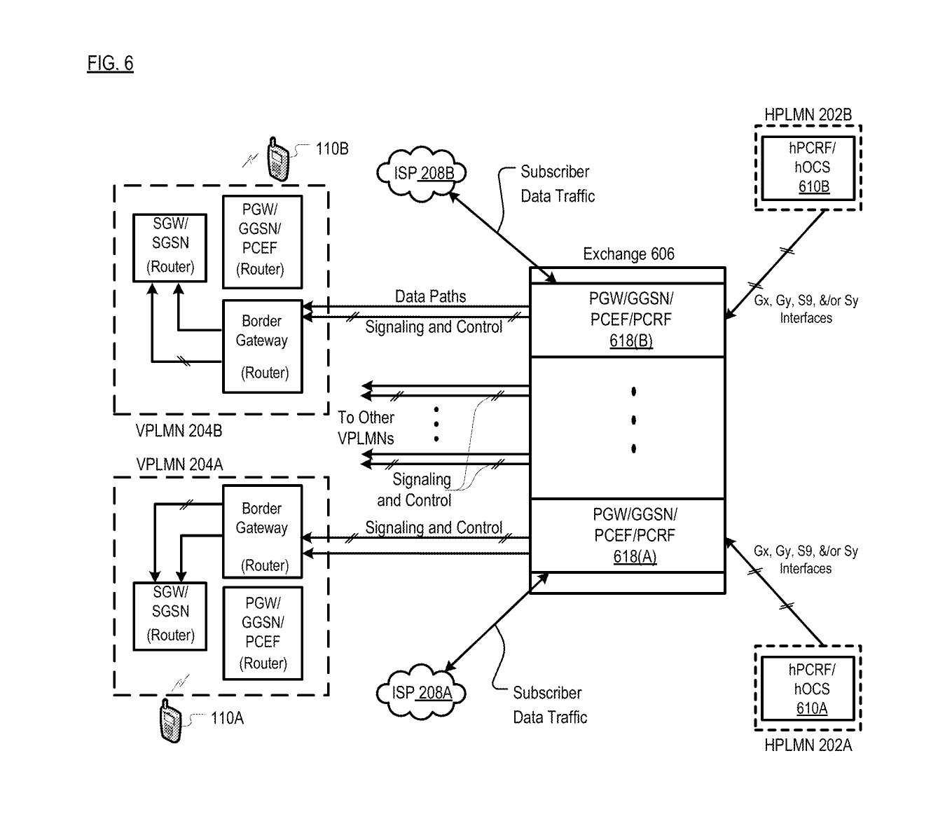

Exchange 606, depicted in FIG. 6, has a similar configuration to exchange 506. However, in this embodiment, the dedicated PGW/GGSN/PCEF instance (for each home network) that is located in exchange 606 interface with the corresponding HPLMN PCRF (hPCRF) and/or OCS (hOCS) in the HPLMN network via Gx, GY, and/or Sy interfaces. Optionally, exchange 606 may include a PCRF instance that acts similar to a vPCRF (reference GSMA IR.88) and interface to the hPCRF via the S9 interface.

For example, instance of PGW/GGSN/PCEF/PCRF 618A receives traffic/instructions from hPCRF or hOCS 610A of HPLMN 202A. The traffic/instructions traverses instance of PGW/GGSN/PCEF/PCRF 618(A). Data traffic obtained via ISP 208A is routed via PGW/GGSN/PCEF/PCRF 618(A) to VPLMN 204A and then to subscriber 110A. HPLMN 202A can also route to VPLMN 204B. Similarly, HPLMN 202B can route to either VPLMN 202A or VPLMN 202B via its instance of PGW/GGSN/PCEF/PCRF 618(B).

This embodiment of an improved LBO architecture and method enables/requires, in addition to any other capabilities and benefits:
An approach by which a home network can establish RBO, which provides similar benefits to LBO, without any involvement of the visited network;
An approach by which far more sophisticated and consistent roaming policies can be established across visited networks without regard to any limitations of VPLMN's equipment; and
An approach that allows an HPLMN to quickly modify and/or rollout new policy plans to meet dynamic market demands. An approach that requires only cooperation with the Regional Exchange provider as opposed to obtaining the cooperation of potentially a hundred or more VPLMN partners.
A minimal amount of integration and test to various endpoints.

What is claimed:

1. A method for enabling mobile policy exchange across plural mobile operator networks, wherein the method comprises:
receiving, at a data processing system, first information pertaining to a policy applicable to a first mobile subscriber that is transmitted from a first home mobile network, wherein the first mobile subscriber wishes to access first data while being serviced by a first visited mobile network;
receiving, at the data processing system, second information pertaining to a policy applicable to a second mobile subscriber that is transmitted from the first home mobile network, wherein the second mobile subscriber wishes to access second data while being serviced by a second visited mobile network;
transmitting, using a Diameter Signal Controller in the data processing system, the received first information to a policy charging and enforcement function server in the first visited network; and
transmitting, using the Diameter Signal Controller in the data processing system, the received second information to a policy charging and enforcement function server in the second visited network,
wherein:
(a) in possession of the first information, the first visited network routes a request for the first data to a first data service and delivers, to the first mobile subscriber, the first data from the first data service; and
(b) in possession of the second information, the second visited network routes a request for the second data to a second data service and delivers, to the second mobile subscriber, the second data from the second data service.

2. The method of claim 1 wherein the method further comprises:
receiving, at the data processing system, third information pertaining to a policy applicable to a third mobile subscriber that is transmitted from a second home mobile network, wherein the third mobile subscriber wishes to access third data while being serviced by a third first visited mobile network;
transmitting, using the Diameter Signal Controller in the data processing system, the received third information to a policy charging and enforcement function server in the third visited network; and
wherein, in possession of the third information, the third visited network routes a request for the third data to a third data service and delivers, to the third mobile subscriber, the third data from the third data service.

3. The method of claim 1 wherein receiving further comprises receiving, at the data processing system, the first and second information from the first home network via a Gx interface.

4. The method of claim 1 wherein the mapping further comprises mapping the received first information to a policy charging and enforcement function server in the first visited network via a Gx interface and mapping the received second information to a policy charging and enforcement function server in the second visited network via a Gx interface.

5. The method of claim 1 wherein receiving further comprises receiving, at the data processing system, the first and second information from the first home network via a Gy interface.

6. The method of claim 1 wherein the mapping further comprises mapping the received first information to a policy charging and enforcement function server in the first visited network via a Gy interface and mapping the received second information to a policy charging and enforcement function server in the second visited network via a Gy interface.

7. A method for mobile broadband roaming, wherein the method comprises:
receiving, at a data processing system, first information pertaining to a policy applicable to a first mobile subscriber that is transmitted from a first home mobile network, wherein the first mobile subscriber wishes to access first data while being serviced by a first visited mobile network, and wherein the first information is received by a first instantiation of a policy charging and rules function or online charging system dedicated for use by the first home mobile network;
receiving, at the data processing system, second information pertaining to a policy applicable to a second mobile subscriber that is transmitted from a second home mobile network, wherein the second mobile subscriber wishes to access second data while being serviced by the first visited mobile network, and wherein the first information is received by a second instantiation of a policy charging and rules function or online charging system dedicated for use by the second home mobile network;
transmitting the received first information to a policy charging and enforcement function server in the first visited network; and
transmitting the received second information to the policy charging and enforcement function server in the first visited network,
wherein:
(a) in possession of the first information, the first visited network routes a request for the first data to a first data service and delivers, to the first mobile subscriber, the first data from the first data service; and
(b) in possession of the second information, the first visited network routes a request for the second data to a second data service and delivers, to the second mobile subscriber, the second data from the second data service.

8. The method of claim 7 wherein the first information is transmitted over a Gx interface.

9. The method of claim 7 wherein the second information is transmitted over a Gy interface.

10. The method of 7 further comprising receiving, at the data processing system, third information pertaining to a policy applicable to a third mobile subscriber that is transmitted from the first home mobile network, wherein the third mobile subscriber wishes to access third data while being serviced by a second visited mobile network, and wherein the third information is received by the first instantiation of a policy charging and rules function or online charging system; and
transmitting the received third information to the policy charging and enforcement function server in the second visited network, wherein:
in possession of the third information, the second visited network routes a request for the third data to a third data service and delivers, to the third mobile subscriber, the third data from the third data service.

11. A method for mobile broadband roaming, wherein the method comprises:
receiving, at a data processing system, first information pertaining to a policy applicable to a first mobile subscriber that is transmitted from a first home mobile network, wherein the first mobile subscriber wishes to access first data while being serviced by a first visited mobile network;
receiving, at the data processing system, second information pertaining to a policy applicable to a second mobile subscriber that is transmitted from a second home mobile network, wherein the second mobile subscriber wishes to access second data while being serviced by a second visited mobile network, wherein:
the data processing system comprises a first instantiation of packet gateway and a policy control and enforcement function dedicated for use with the first home mobile network and a second instantiation of a packet gateway and a policy control and enforcement function dedicated for use with the second home mobile network;
transmitting a request, from the first instantiation of the packet gateway and policy control and enforcement function to a first data service, for the first data;
transmitting a request, from the second instantiation of the packet gateway and policy control and enforcement function to a second data service, for the second data;
receiving the first data and the second data;
transmitting the first data to the first visited network; and
transmitting the second data to the second visited network.
